(19) United States
(12) Patent Application Publication
(10) Pub. No.: US 2006/0228983 A1
(43) Pub. Date: Oct. 12, 2006

(54) Hip hop dolls, animals, bears/ rapping dolls, animals, bears

(76) Inventor: Taylor Christopher Carthern, Atlanta, GA (US)

Correspondence Address: Taylor Carthern, 110 Old Fairburn Close, Atlanta, GA, 30331, US

(21) Appl. No.: 11/103,057

(22) Filed: Apr. 11, 2005

(51) Int. Cl. A63H 3/28; A63H 3/08; G09B 19/00

(52) U.S. Cl. 446/297; 446/98; 434/156; 273/299; 40/299.01; 2/1; 150/106

(57) ABSTRACT

My invention will involve stuffed teddy bears, dolls, animals and puppets that will speak hip-hop slang, Ebonics, rapping words and phrases. The bears will have a chip with a pre-recorded message on it that would be activated by pressing a button on the animals. The animals will be dressed in hip or urban clothes and you will also be able to buy more clothes for a certain animal. The animals will say phrases such as Wats up shawty? Or Bling bling. They may even rap there name. Ex. If you have a bear name Eddie the Mac. He may rap something like Its yur boy E-D-D-I-E- coming ready like Freddy chillin like penicillin cuz Im a mac. The games will include a monopoly game where you would get through the board by using hip-hop phrases and words. The match game would include a game where the players will have to draw cards with hip-hop expressions on them. On one side would be the proper English expression and the other would be the hip-hop or Ebonic translation. You drew a card that said How are you doing? The player would have to say the Ebonic translation of this which would be Wats da bizness? Some animals will wear T-shirts with entertainers and celebrities pictures on them and the shirts will have a pre-recorded message from the celebrity talking, singing, or rapping. A T-shirt with the entertainers picture and name that will have a message from that celebrity. Their message will be heard upon pressing a button that will sound through a speaker on the front of the T-shirt. The button and speaker will be on the front of the T-shirt where the words are located. A purse or jewelry case with a space for a picture for a person and a pre-recordable and recordable device that says a message. This method will be used for celebrities and individuals. Gold, or silver grill in the mouth of bears. A pre-recordable device and recordable device that will be placed on a rose to play a special song, snippet, and say a special personal message.

### FIELD OF INVENTION

Teddy Bears and animals, dressed in hip-hop clothes, with pre-recorded messages in them that allows them to say hip-hop slang and Ebonic words and phrases.

### BACKGROUND OF INVENTION

This present invention relates to having stuffed animals that will have electronic devices in them that will allow them to speak slang, Ebonics, and hip hop.

### DESCRIPTION OF RELATED INVENTIONS

The ornamental design for a teddy bear in racecar driver's clothing, as shown and described. Pat. D469,480.

### SUMMARY OF INVENTION

Our new invention involves dolls and animals that speak Ebonics, hip-hop slang and rapping. A pre-recorded chip that will allow dolls and animals to say words in Ebonics, hip-hop slang and rapping. We will be using recordable dolls, animals, and bears. We would also like to use our bears, dolls, and animals for creating games. Games like monopoly that tell you how to move in hip-hop slang or rap. The game will have hip-hop places like clubs, rim shops, music stores, jewelry stores, millionaire houses. We would have games that will teach you hip-hop slang and how to talk hip. We will have talking robots, talking cars, posters that has an entertainer to talk to you, match hip-hop playing cards, you have to match cards with the matching hip-hop slogans. We would have a game where you would have to match the hip-hop slang or Ebonic slang with proper talking. Ex. How are you doing today? Translation: Wats hapenin?. All bears, dolls, and animals will wear T-shirts with the entertainers and picture name that will also have a pre-recorded message of that entertainer. A T-shirt with the entertainers picture and name that will have a message from that celebrity. Their message will be heard upon pressing a button that will sound through a speaker on the front of the T-shirt. Ex. A bear with a T-shirt on that has a picture of Usher that has a pre-recorded message from Usher upon touching a bear. The pre-recorded message can be talking or singing or rapping. The device is pre-recordable and recordable and is in the T-shirt, and some will be washable and some will have to be taking out and placed back in the T-shirt. The button and speaker will be on the front of the T-shirt where the words are located. A purse or jewelry case with a space for a picture for a person and a pre-recordable and recordable device that says a message. This method will be used for celebrities and individuals. Gold, or silver grill in the mouth of bears. An electronic device that will have a pre-recordable message on it or it will be recordable, it will be attached to a rose and will play a song or have a special romantic message on it. A pre-recordable device and recordable device that will be placed on a rose to play a special song, snippet, and say a special personal message.

### BRIEF DESCRIPTION OF DRAWINGS

FIG. 1 displays one of the hip hop dolls. FIG. 1—100 shows a grill in the mouth of the doll. The grill is interchangeable and can be placed in the mouth or taken out of the bear. FIG. 1—100-A gives you a better view of the grill. FIG. 1—200 represents the earring that the bear is wearing and FIG. 1—300 represents the glasses that the bear has on.

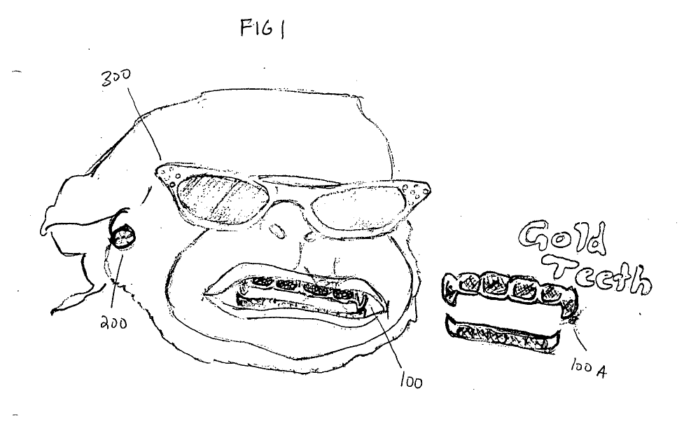

FIG. 2 represents another hip-hop bear/doll with urban glasses on. FIG. 2—100 represents the grill displaying $ice in the mouth of the bear. FIG. 2—100A shows a more detail view of the grill so you can read the word. FIG. 2—200 shows the hat with words ICE on it.

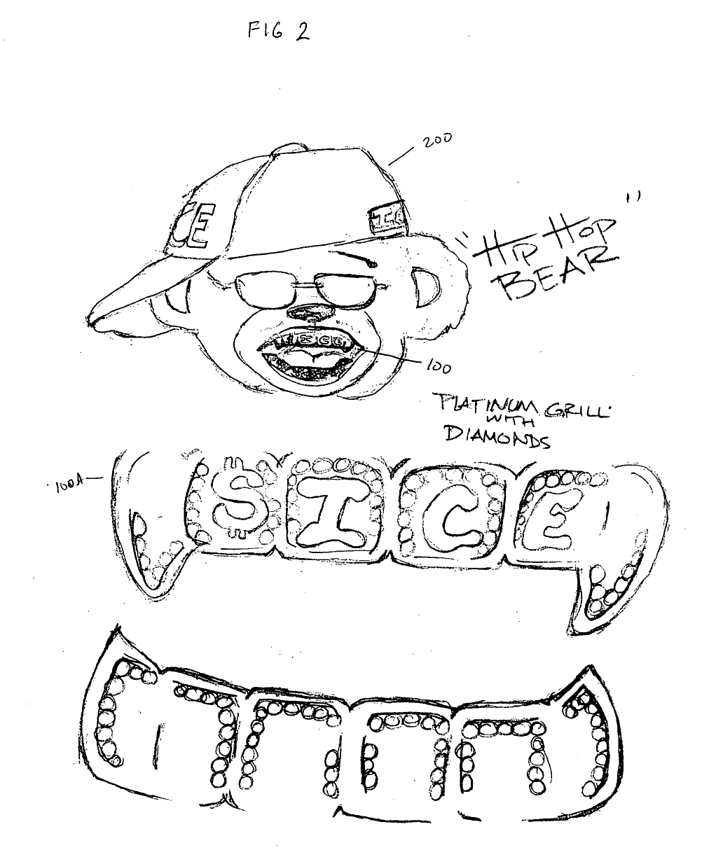

FIG. 3 represents the bear in color with a chain around his neck with an urban white tee look. The bear also has on a scarf, earrings and some glasses.

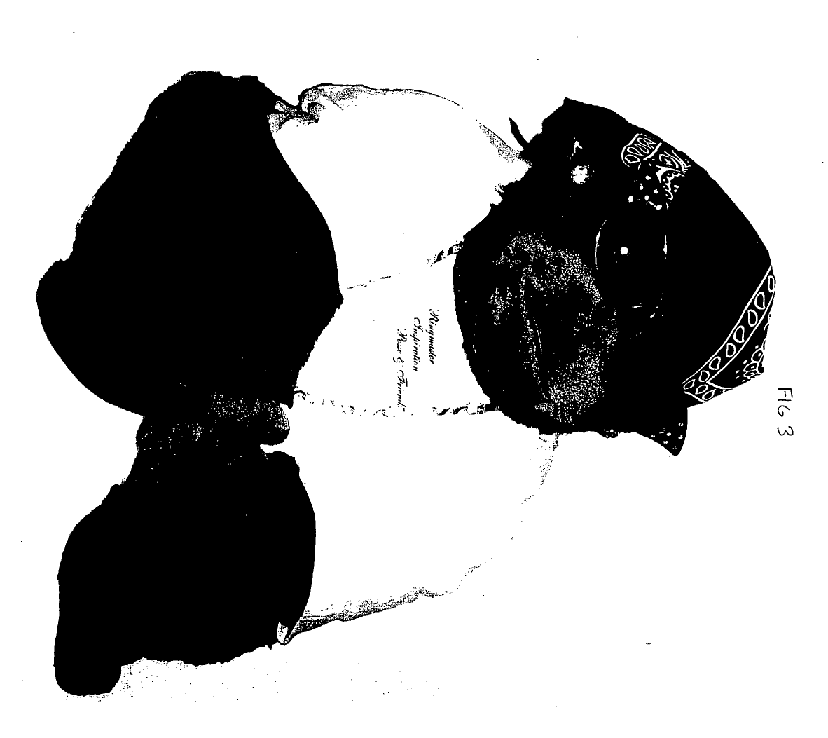

FIG. 4 represents a bear with a more urban look with a cell phone on its ear, and some glasses on its face. The suit will be interchangeable where you can buy new outfits and accessories to match, like the hat in the picture.

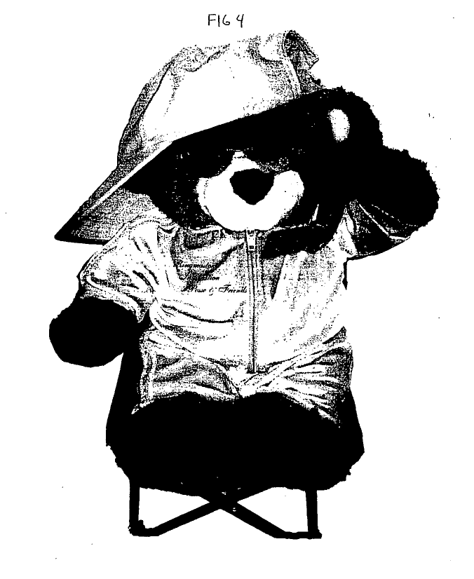

FIG. 5 represents a picture of the rose with the electronic device that can be placed on it and upon pressing it; it will play a song or a recorded message. FIG. 5—100 represents the electronic device on the flower that will play either a recorded or pre-recorded message.

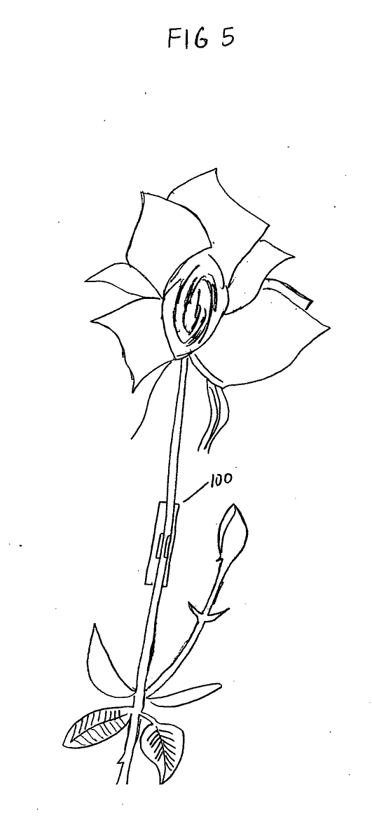

FIG. 6 is a diagram of the electronic chip that the pre-recorded messages to be put into the animals and in the inside of T-shirts in a pocket, to and from gift labels, roses and purses. FIG. 6A represents the PCB that the message is recorded to and FIG. 6B represents the chip connected to the recorded device that is its source of power. FIG. 6C displays the batteries that power the recording device. FIG. 6D displays the button that you press to hear the message.

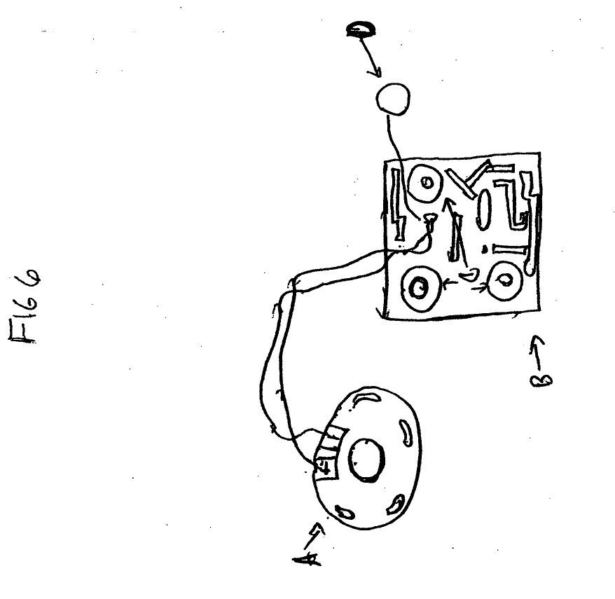

FIG. 7 is a picture that represents the electronic device that will be used for the in the inside of T-shirts in a pocket, the to and from gift labels, roses, animals and purses. FIG. 7A, displays where the microphone is located on the card and represents the button that you would press to listen to the message. FIG. 7B represents the light that let you know if your message is recording or not. If you are recording then it will be red. FIG. 7C is the button that you press and hold to record your message. As you press these buttons the red light will come on. FIG. 7D represents the PCB sound chip that is connected to two small batteries, which everything is connected to. FIG. 7E FIG. 6A represents the PCB that the message is recorded to

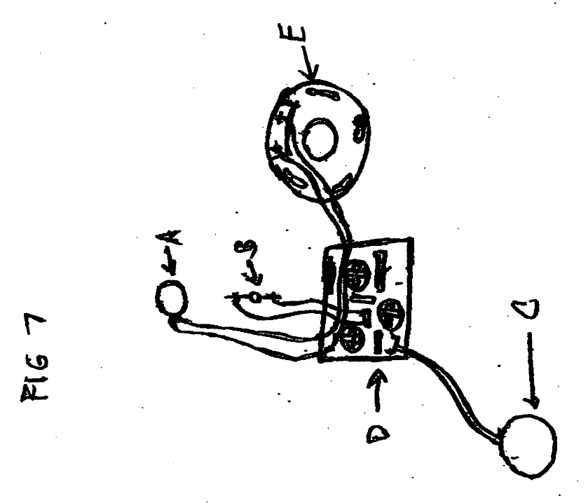

### DETAILED DESCRIPTIONS OF DRAWINGS

My invention will involve stuffed teddy bears, dolls, animals and puppets that will speak hip-hop slang, Ebonics, rapping words and phrases. The bears will have a chip with a pre-recorded message on it that would be activated by pressing a button on the animals. The animals will be dressed in hip or urban clothes and you will also be able to buy more clothes for a certain animal. The animals will say phrases such as Wats up shawty? Or Bling bling. They may even rap there name. Ex. If you have a bear name Eddie the Mac. He may rap something like Its yur boy E-D-D-I-E- coming ready like Freddy chillin like penicillin cuz Im a mac.

The games will include a monopoly game where you would get through the board by using hip-hop phrases and words. The match game would include a game where the players will have to draw cards with hip-hop expressions on them. On one side would be the proper English expression and the other would be the hip-hop or Ebonic translation. You drew a card that said How are you doing? The player would have to say the Ebonic translation of this which would be Wats da bizness?

Some animals will wear T-shirts with entertainers and celebrities pictures on them and the shirts will have a pre-recorded message from the celebrity talking, singing, or rapping. A T-shirt with the entertainers picture and name that will have a message from that celebrity. Their message will be heard upon pressing a button that will sound through a speaker on the front of the T-shirt. Ex. A bear with a T-shirt on that has a picture of Usher that has a pre-recorded message from Usher upon touching a bear. The device is pre-recordable and recordable and is in the T-shirt, and some will be washable and some will have to be taking out and placed back in the T-shirt. The button and speaker will be on the front of the T-shirt where the words are located. A purse or jewelry case with a space for a picture for a person and a pre-recordable and recordable device that says a message. This method will be used for celebrities and individuals. Gold, or silver grill in the mouth of bears.

Operation of Invention

The invention includes some primary parts, the dolls, bears and stuffed animals, that will wear urban clothes and speak hip-hop Ebonics and slang. It will have a electronic device in them that will have their pre-recorded message and we will have several different types of games that will help you match slang words and so on. The animals will also wear T-shirts with celebrities pictures on them and will have their pre-recorded message on them.

What I claim as my invention is:

1. The use of dolls, bears, animals and puppets, wearing hip-hop clothes, and/or jewelry and/or jewelry, that will be interchangeable, that will speak Ebonics, hip-hop slang and rapping.

2. An apparatus used as a device, that will have a button to play the voice message and a speaker to hear the message, to pre-record hip-hop slang, Ebonics, and rapping that would be placed in the dolls, bears, and animals, to and from gift labels and T-shirts.

3. The use of stuffed animals and dolls that will speak Ebonics, hip-hop slang and rapping wearing hip-hop clothes, and/or jewelry, that will be interchangeable.

4. The use of dolls that will speak Ebonics, hip-hop slang.

5. The use of bears and puppets that will speak Ebonics, hip-hop slang and rapping wearing hip-hop clothes, and/or jewelry, and/or grill with imitation diamonds in them, that will be interchangeable and sold separately with accessories.

6. Games that teach you hip-hop slang or rap.

7. Playing card game that matches cards with hip-hop slogans.

8. Games that would have you match a proper English word or phrase with the hip-hop slang or Ebonic translation.

9. The use of stuffed animals, dolls, bears, animals and puppets, that will wear celebrities T-shirts that will have their voice message pre-recorded using the device from claim 2, on the shirt.

10. The use of stuffed animals, dolls, bears, animals and puppets, in with gold and silver grills in their mouth, with the grill having fake or imitation diamonds, and the use of wax grills for sale tha you can put into your mouth and wear to look like platinum, gold, silver and with diamonds (like fangs on Halloween or any day throughout the year).

11. The use of stuffed animals, dolls, bears, animals and puppets, with gold and silver grills that are exchangeable and can be taken out of the animals mouth and placed back on its teeth, with its name on the grill, with the grill having fake or imitation diamonds.

12. The use of to and from gift labels, normally on the outside of gifts, on different types of gifts, that will have electronic device, that will have a button to play the voice message and a speaker to hear the message, and in them a button to press and record a personalized message or will contain a pre-recorded message from our stuffed animals, dolls, bears, animals and puppets, or celebrity.

13. The use of the electronic device, that will have a button to play the (any voice and sound) voice message and a speaker to hear the message, to in claim 15 that will be used for any gifts that may be rapped, or gift bag for all occasions (birthdays, valentines day, Christmas, etc.).

14. The use of a recordable or pre-recordable device for T-shirts, sweatshirts and or dress shirts (long sleeve, short sleeve, sleeveless), that will have a button to play (voice and/or sound) the message and speakers to hear the message (for pre-recordable device) and have a button to play voice and/or sound and speakers to hear the message and a button to record a message (for recordable device) both device will be locate on the backside of picture inside a pocket on T-shirt, sweat-shirt and or dress-shirts or any other place on T-shirt, sweat-shirt and or dress-shirt the device is not limited to any particular place on T-shirt, sweat shirt and or dress shirt. The device could be place anywhere on T-shirt, Sweat-shirt and or dress-shirt. Some of the device will be washable (waterproof) and some device will be non-washable removable, in which the device will have to be removed from the T-shirt, sweatshirt and or dress shirt to be washed, and the T-shirt, sweatshirt and or dress-shirt will have a picture and voice message from the dolls, bears, animals and puppets or celebrities in which T-shirts, sweatshirt and or dress shirt are available for people to wear. The device will be inserted in the inside and the outside of a T-shirt, sweatshirt and or dress shirt, pocket where you can remove it to wash the T-shirt, sweatshirt and or dress shirt. (The pocket will be the size of a card and the pocket will be sewn on the inside of the shirt and some pockets will have zippers. The play button will be on the outside of the T-shirt, sweatshirt and or dress-shirt where the picture is located. To here voice and or sound press the play button outside the picture on T-shirt sweatshirt and dress-shirt and or any other place the play button is on T-shirt, sweatshirt and or dress-shirt. The play button is not limited to any particular area on T-shirt, sweatshirt and or dress shirt.

15. A purse or jewelry case with a space for a picture for a person and a pre-recordable (that will have a button to play the message) and/or recordable (that will have a button inside the picture to record the message, and play the message.) device, button inside of the picture, press picture to play the message.

16. A electronic device, that will have a button to play the voice message and a speaker to hear the message and a button to record a message, to that will have a pre-recordable message on it or it will be recordable, it will be attached to a rose and will play a song or have a special romantic message on it.

17. A pre-recordable device and recordable device, that will have a button to play the voice message and a speaker to hear the message, to that will be placed on a rose to play a special song, snippet, and say a special personal message.

18. The prerecorded or recordable device can be on to and from card or sold separately from the rose that can be attached to the rose and any pre-recordable and recordable device that has voice and/or sound that is used to attach to a rose in any form of attachment and is sold separately or together with the rose.

19. Any device sold with or without T-shirt, sweatshirt and or dress-shirt sold with voice and/or sound in it.

20. Any device sold with or without to and from gift label and/or card (that is used as a voice greeting for gifts) with voice and/or sound and any device that has sound and/or voice to be attached to any rose.
